(19) United States
(12) Patent Application Publication
(10) Pub. No.: US 2025/0322769 A1
(43) Pub. Date: Oct. 16, 2025

(54) EYE MODEL FOR LASER EXCISION

(71) Applicants: Nathaniel R. Collins, Monrovia, CA (US); Nico J. Slabber, Eastvale, CA (US); Vijay R. Balan, Torrance, CA (US)

(72) Inventors: Nathaniel R. Collins, Monrovia, CA (US); Nico J. Slabber, Eastvale, CA (US); Vijay R. Balan, Torrance, CA (US)

(21) Appl. No.: 19/173,688

(22) Filed: Apr. 8, 2025

Related U.S. Application Data
(60) Provisional application No. 63/634,627, filed on Apr. 16, 2024.

(51) Int. Cl. G09B 23/30

(52) U.S. Cl. CPC G09B 23/30

(57) ABSTRACT

A simulated eye surgical model, namely a laser excision region, that facilitates training of ophthalmic surgical procedures as well as testing and calibration of laser systems, such as laser-based glaucoma treatment.

### RELATED APPLICATIONS

The present application claims priority to U.S. provisional Ser. No. 63/634,627, filed Apr. 16, 2024, the contents of which are expressly incorporated herein.

### FIELD OF THE INVENTION

The present application is directed to a simulated eye surgical model and, in particular, to an eye model that facilitates training of ophthalmic surgery procedures as well as testing and calibration of laser systems, for laser-based glaucoma treatment.

### BACKGROUND OF THE INVENTION

Glaucoma is a blinding optic neuropathy affecting approximately 70 million individuals worldwide. Its main risk factor is elevated intraocular pressure (IOP). The trabecular meshwork (TM), a group of tiny canals located in the iridocorneal angle, constitutes the main pathway for drainage of aqueous humor out of the eye. It is a fenestrated three-dimensional structure composed of trabecular meshwork cells (TMC) within a multi-layered extracellular matrix (ECM). The trabecular meshwork controls the IOP by regulating outflow of aqueous humor from the anterior chamber (AC) of the eye into the adjacent Schlemm's canal (SC) and then via aqueous vein collector channels into the venous system. Dysfunction of the trabecular meshwork is one major cause of IOP elevation.

Goniotomy is a surgical procedure in which an opening is made in the TM where fluid leaves the eye. The new opening provides a way for fluid to flow out of the eye. The procedures to make this opening in the TM include lasers, excising tissue via instruments and stents.

What is needed is a model human eye that closely mimics the anatomy and physiology of the human eye for particular procedures.

### SUMMARY OF THE INVENTION

This application presents a simulated eye with a coating and rim to represent the trabecular meshwork and angle structures, respectively, that simulates the response of human tissue during laser-based glaucoma ophthalmology procedures.

The application presents a TM represented by a coating and structure (rim), specifically for use with femtosecond laser systems, including one of more of the following:

TM surface is on a solid body.

A TM design for femtosecond lasers.

A coating that reacts with femtosecond laser for glaucoma surgery.

TM coating that plumes to look like blood reflux.

Can be used be used for methods of laser systems setup.

Can be used as a calibration device and/or functional test.

### BRIEF DESCRIPTION OF THE DRAWINGS

Features and advantages of the present invention will become appreciated as the same become better understood with reference to the specification, claims, and appended drawings wherein:

FIG. 1 shows an anatomical diagram of the aqueous humor cycle through one corner of a human eye, and the enlargement illustrating how fluid exits through Schlemm's canal via the trabecular meshwork (TM);

FIG. 2 shows a fully assembled eye model;

FIG. 3 is an exploded perspective view of certain components of the eye model of FIG. 2, FIG. 4 is a sectional view thereof;

FIG. 5 is an assembled sectional view;

FIG. 6 is an alternate assembled sectional view with an internal cavity;

FIG. 7 is a perspective sectional view demonstrating how a rim structure can represent the iridocorneal angle with a coating as the trabecular meshwork;

FIG. 8 demonstrates how a femtosecond laser can fire on the trabecular meshwork coating;

FIG. 9 demonstrates the plume created by the laser firing;

FIG. 10 demonstrates a completed laser excision of the trabecular meshwork;

FIG. 11 is a sectional view of the rim structure and coating;

FIG. 12 is a sectional view of an alternate type of rim structure with different rear surface;

FIG. 13 is a sectional view of an alternate type of rim structure with angled trabecular meshwork surface;

FIG. 14 demonstrates a synthetic trabecular meshwork covering a Schlemm's canal for canaloplasty via a bent cannula inserted behind the synthetic TM. The thicker black line represents the sheet which creates the Synthetic TM;

FIG. 15 is an alternative eye model having an excisable simulated TM that is being excised via a needle with a bent tip; and

FIG. 16A-16D are diagrams of potential rims.

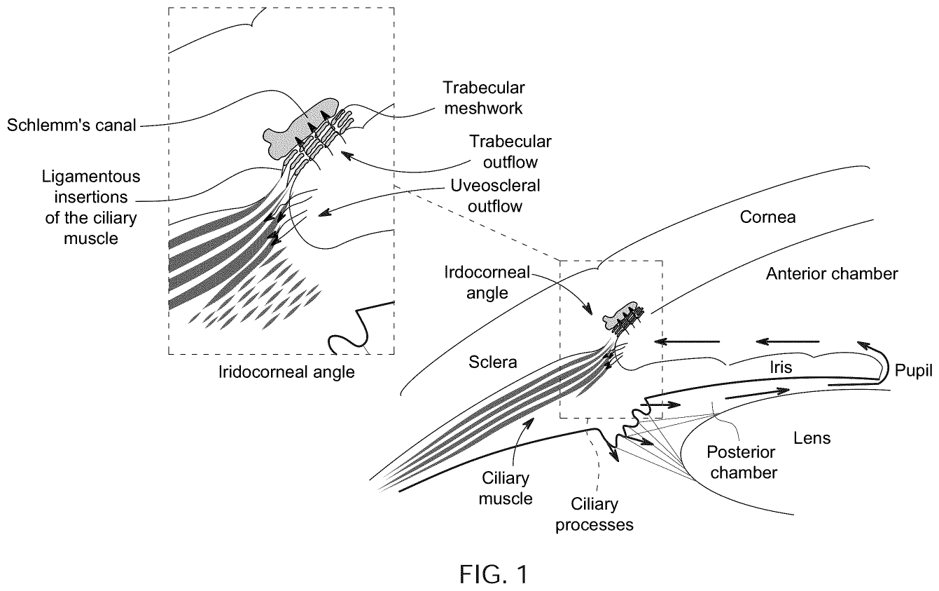

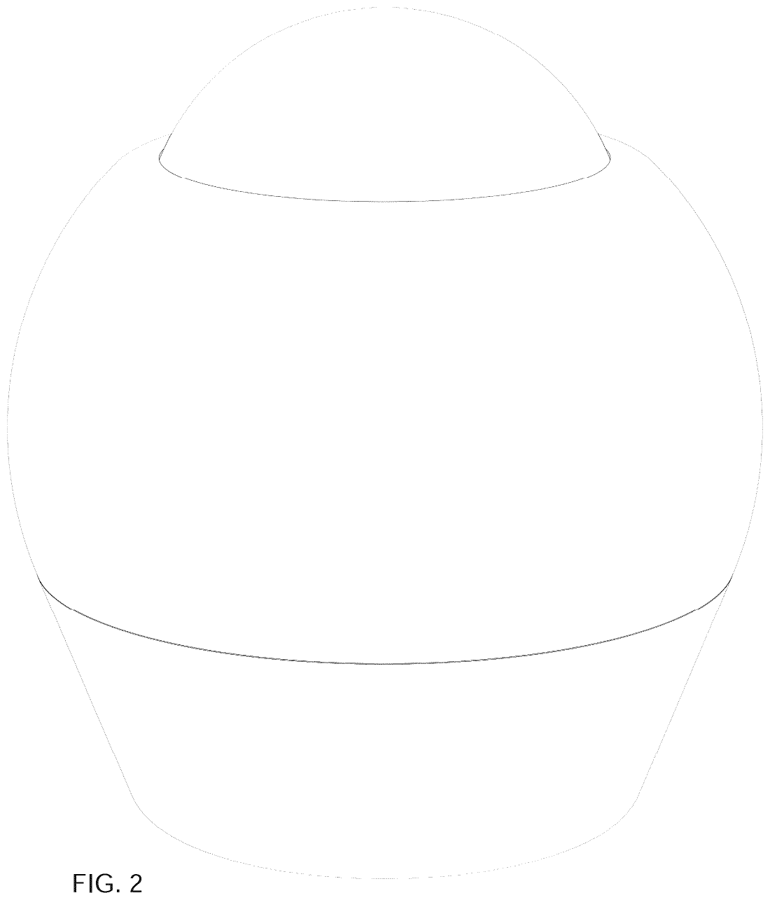

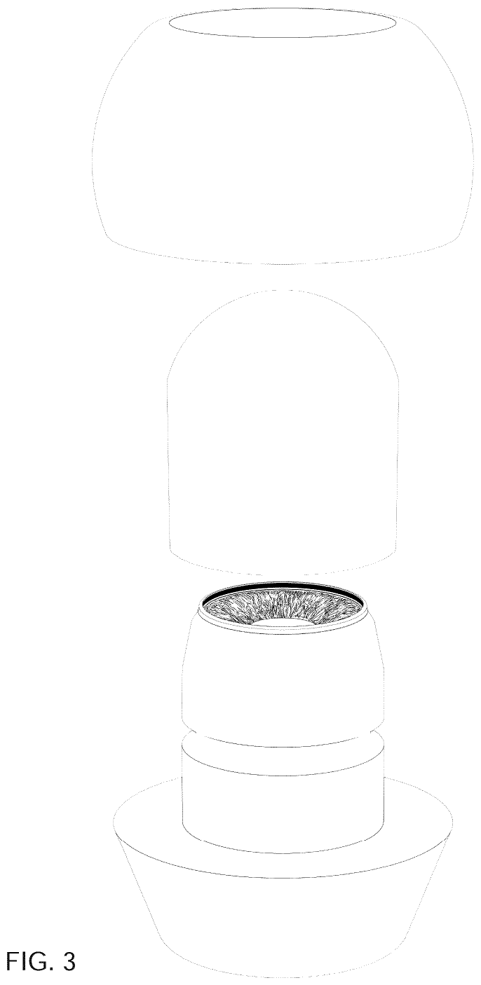

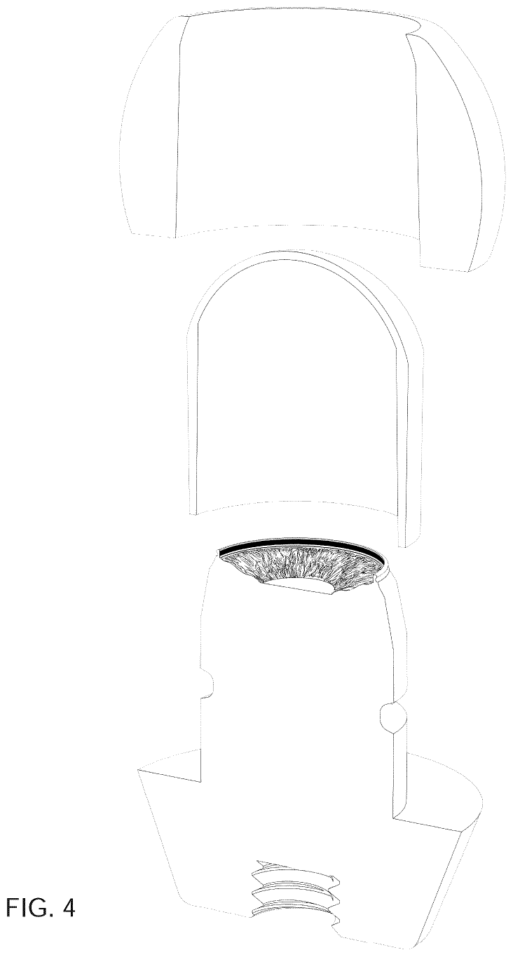

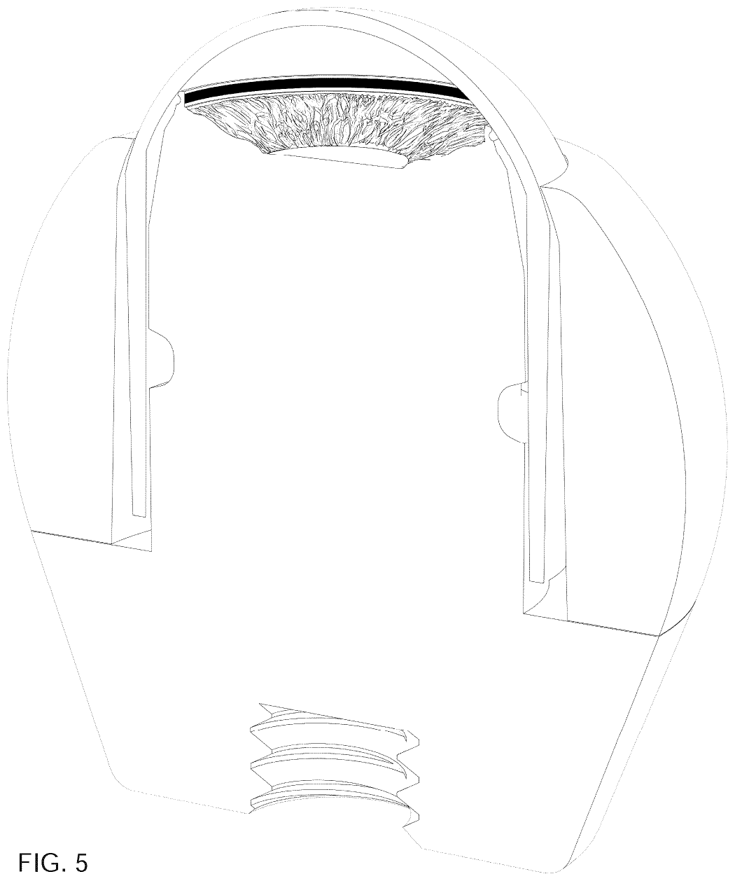

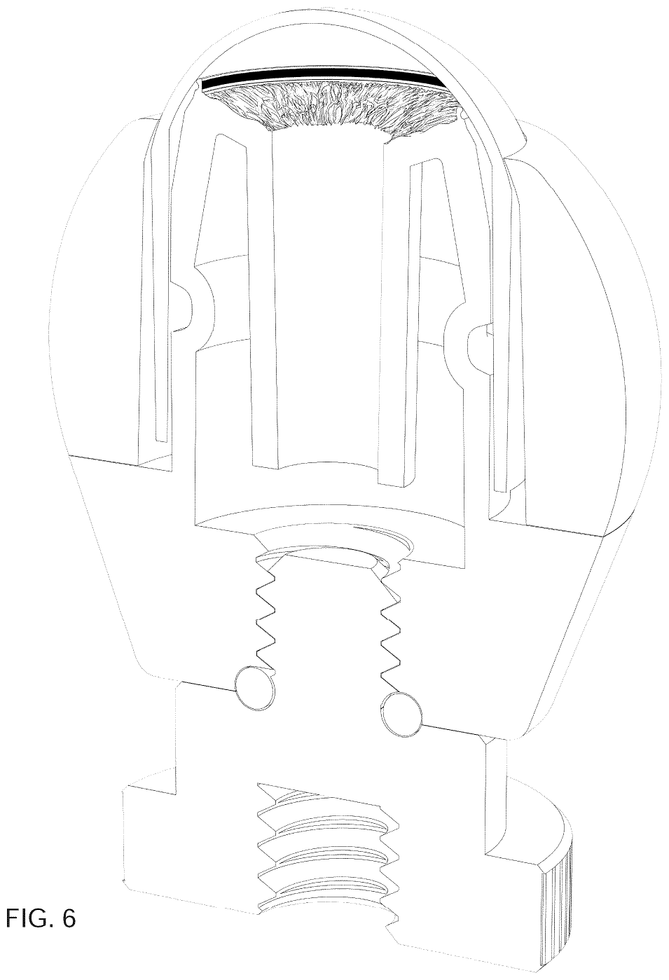

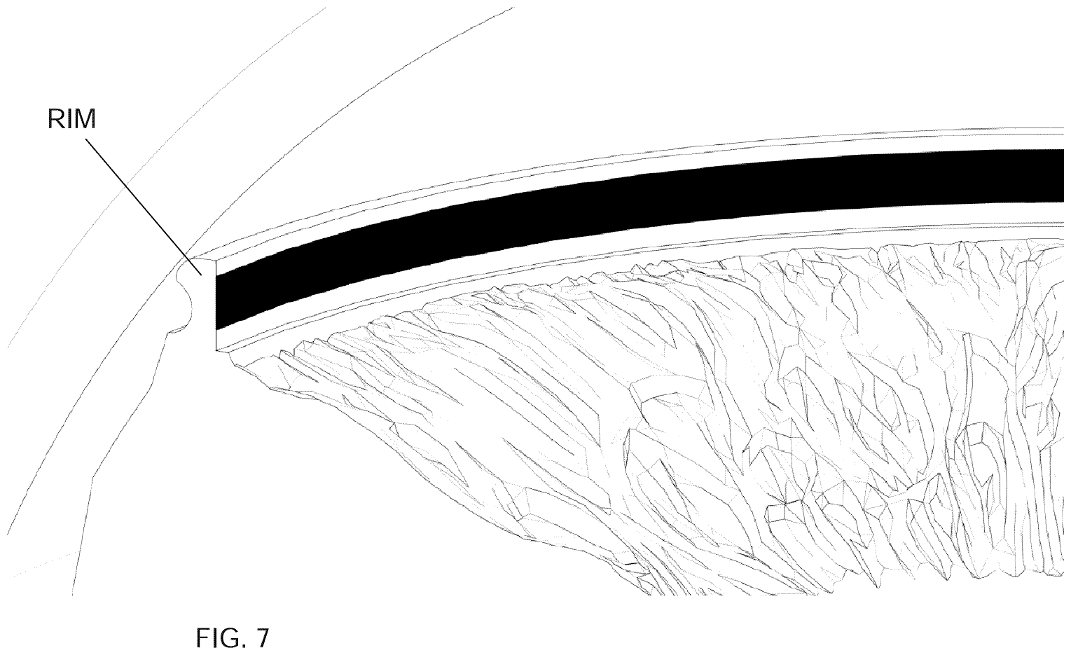

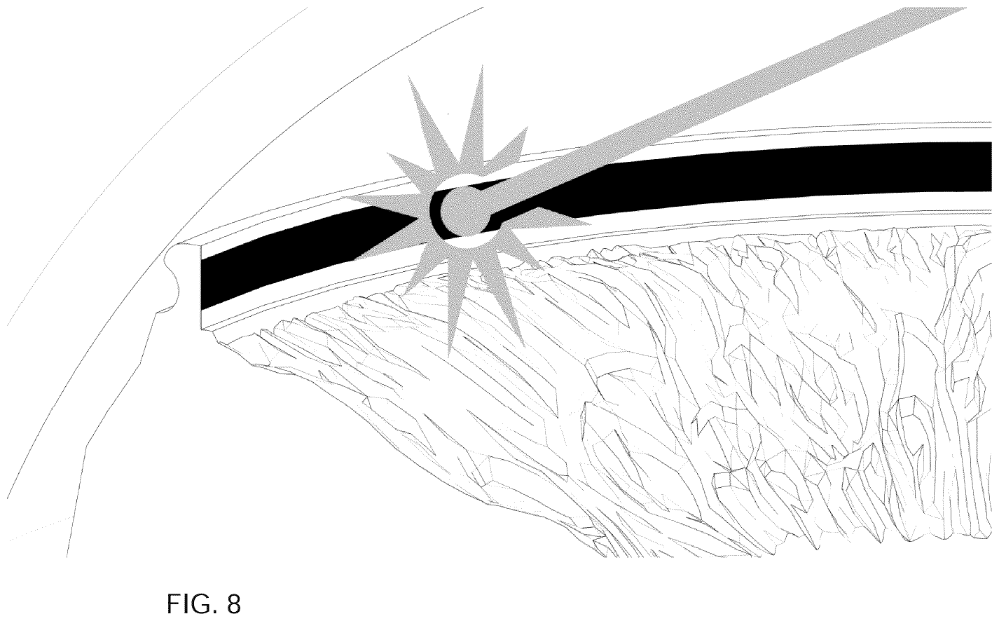

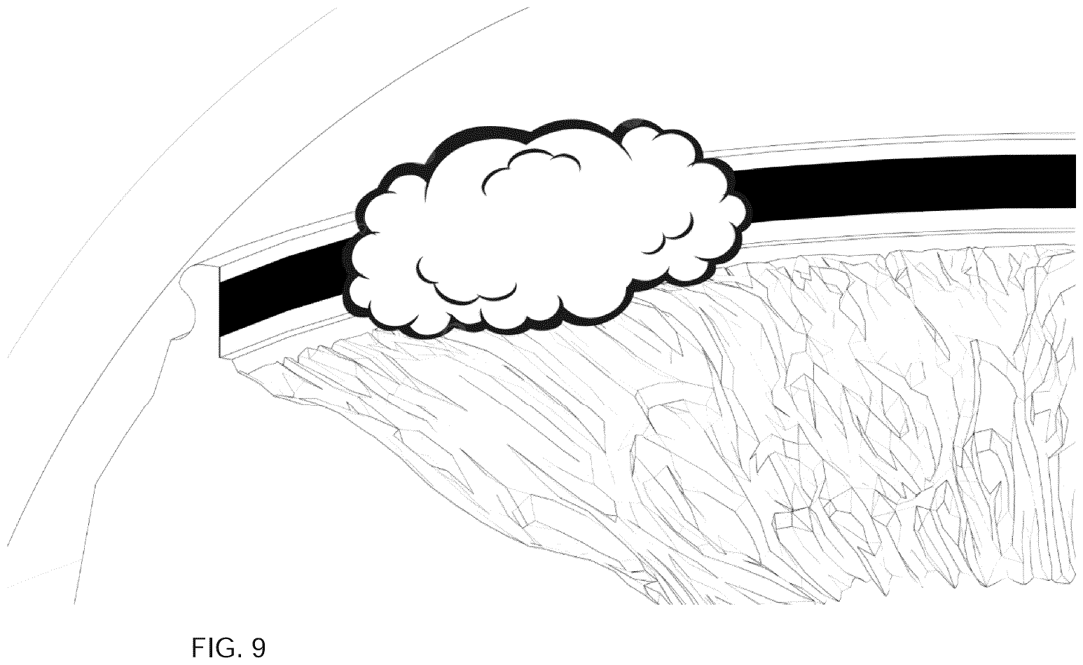

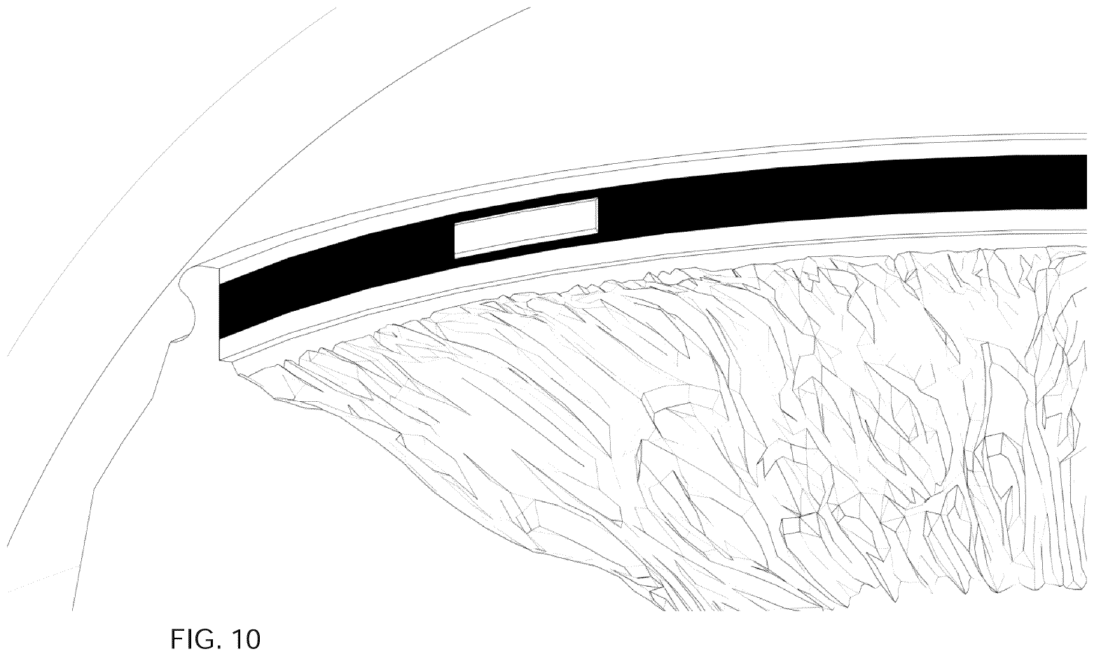

### DETAILED DESCRIPTION OF THE PREFERRED EMBODIMENTS

The present application provides an eye model that uses a coating and rim structure to represent the trabecular meshwork (TM) and angle structures for use with a femtosecond laser for glaucoma treatment simulation.

Glaucoma Surgery with Femtosecond Laser

A femtosecond (FS) laser is an infrared laser that emits bursts of laser energy at an extremely fast rate. This laser has a pulse duration of 1053 nm that operates within one quadrillionth of a second (femtosecond 10\hat{ }-15). This FS laser application creates free electrons and ionized molecules that quickly generate an acoustic shockwave resulting in disrupted optically transparent tissue through a process called photodisruption (photoionization). Collateral damage is minimized dramatically due to the quick pulse duration of a femtosecond laser. In fact, collateral damage with FS laser is 106 times less than with the Nd:YAG laser (neodymium-doped yttrium aluminum garnet laser). The targeted tissue is essentially vaporized, creating a clean excision or pathway for fluid to flow. Normally a blade or dual blade, such as Kahook Dual Blade (KDB) would be needed to cut and excise tissue.

A femtosecond laser offers precise incisions with minimal to no collateral damage to tissue compared to manual incisions created with a blade (Kahook dual blade). Procedures utilizing femtosecond lasers allow penetration into subsequent tissues within the eye without the need of creating corneal incisions. This noninvasive procedure causes fewer complication rates and allows for faster patient recovery.

Currently, glaucoma laser procedures that target the TM include selective laser trabeculoplasty (SLT) with a YAG laser and argon laser trabeculoplasty (ALT). SLT uses a specific wavelength of 532 nm, causing the laser to affect pigmented (melanin-containing) cells of the TM. The selective nature of the laser helps to target pigmented cells while minimizing treatment of non-pigmented cells and thus reduces collateral damage to surrounding structures. However, SLT still causes an increase of collateral damage to surrounding tissues in comparison to an FS laser.

ALT is an older procedure that uses Argon lasers at a pulse duration typically at 488 nm. The beam profile is smaller in comparison to SLT and is capable of treating pigmented and non-pigmented tissues. This can lead to increased issues with adverse events, and in certain cases, cause the development of peripheral anterior synechiae (PAS) and scarring. With SLT, the temperature of the melanin-containing cells rises as they absorb the laser energy. With ALT, electromagnetic energy is converted to thermal energy when it contracts the tissue.

When SLT and ALT laser are used on the TM, tissue contraction and scar formation result. This causes mechanical stretching of the surrounding untreated regions of the meshwork, facilitating flow into SC with subsequent reduction in intra ocular pressure (IOP). There is also a biological response which includes a release of chemical mediators, such as inflammatory cytokines, that improve aqueous outflow. This is stimulating the body's own healing response to lower IOP. A femtosecond laser treatment differs in that it causes full-thickness openings through the TM for direct flow into the SC. The heating process of SLT and ALT cause the formation of bubbles where femtosecond laser vaporization causes plumes of tiny particles and small bubbles.

### Trabecular Meshwork for Laser Simulation

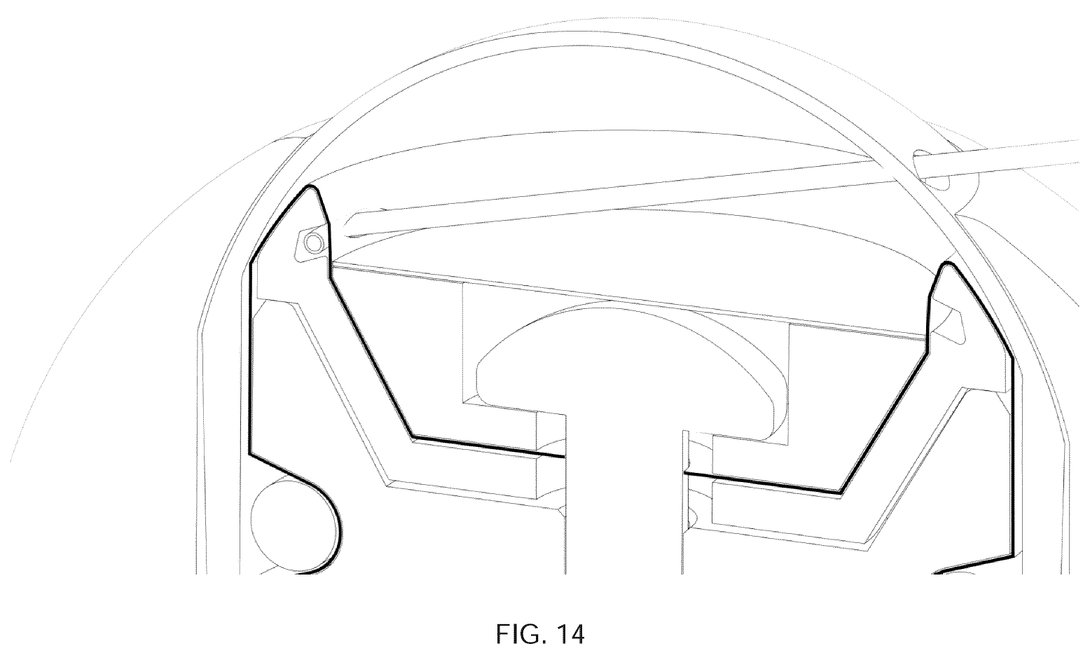

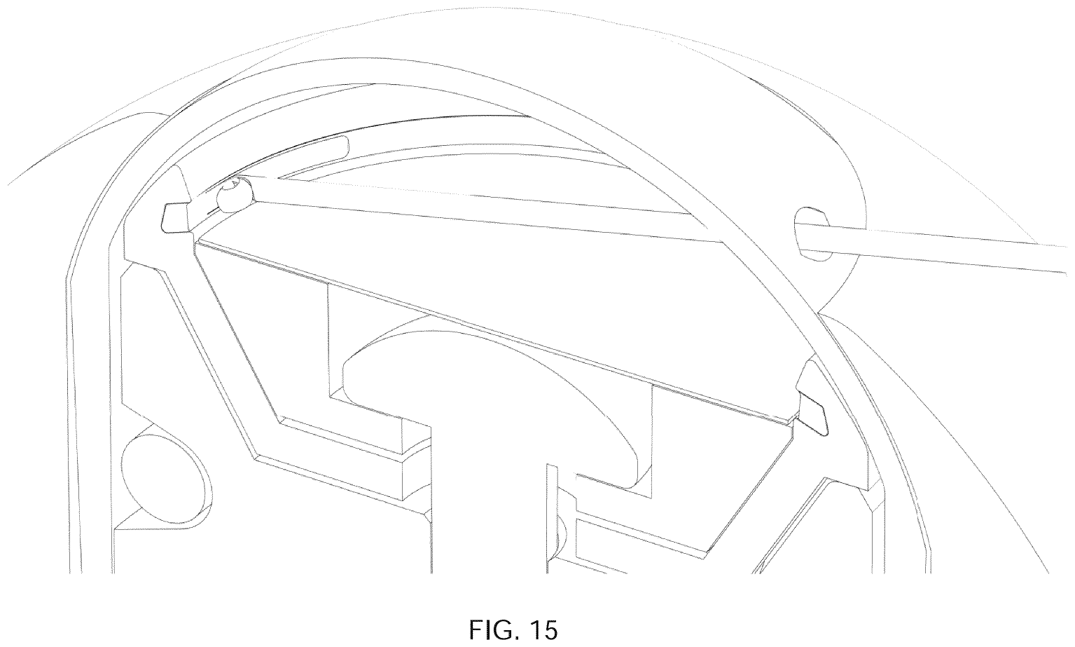

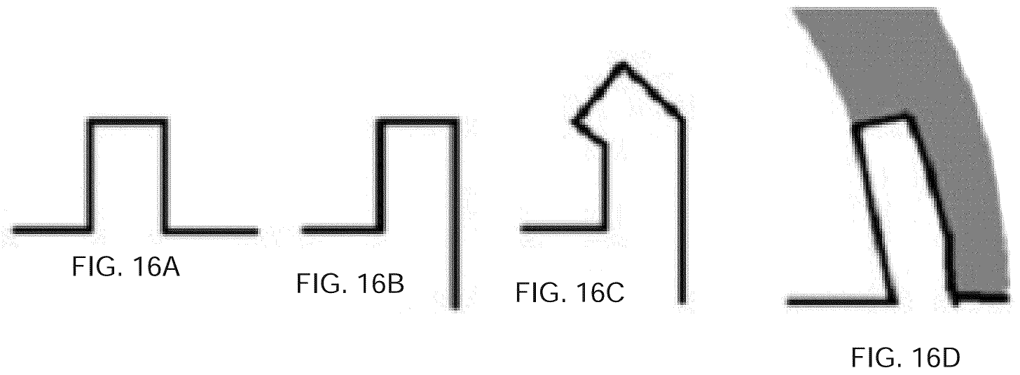

Traditionally, in simulated eye models, the TM is represented as a soft removable compound or penetrable membrane as seen in FIGS. 14 and 15. Using a removable compound for the TM is generally used when excising with a blade is required, such as in goniotomy. When simulating procedures such as canaloplasty or trabeculotomy, it is necessary to penetrate the TM to gain access to Schlemm's canal and the TM will be simulated with a membrane. In these cases, only the properties of the TM needed to simulate the given surgical technique are recreated in the model. The TM has many unique properties and recreating all of these simultaneously in a model would be cost prohibitive. Each glaucoma surgical model is therefore tailoring the TM design to primarily include the characteristics of the particular intended surgery. The use of femtosecond laser for glaucoma treatment is a novel treatment form, and so a novel method of creating a simulated TM is required. This new simulated TM must behave the same as human tissue when exposed to laser treatment in terms of energy required, dissipation, and visualization to name a few.

For this model, a simulated TM has been replicated by apply a coating to a surface to represent the TM. This surface is part of a solid structure (rim) that represents the geometry and location of the TM and iridocorneal structures. The material of the structure that contains the TM coating can also be formulated for opacity when viewed with an optical coherence tomography (OCT) system. This OCT system is a non-invasive imaging device that uses light waves to take cross-section pictures of the TM structure during use. This allows a cross-sectional visualization of the tissue removal depth during the laser procedure.

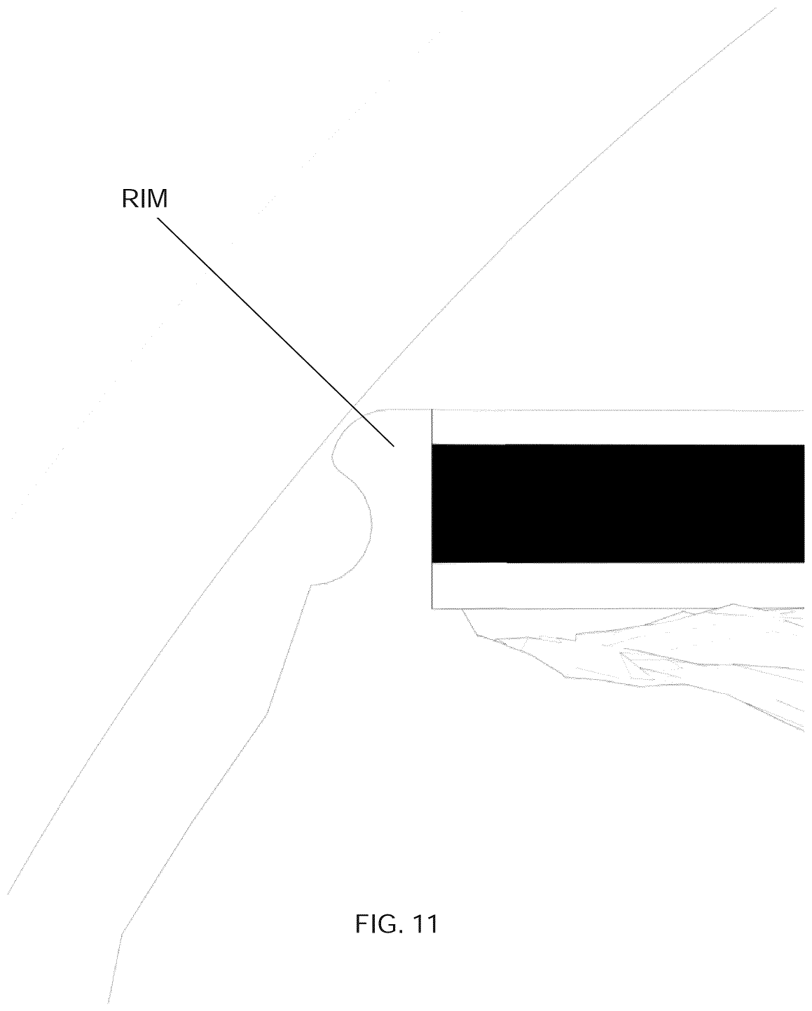

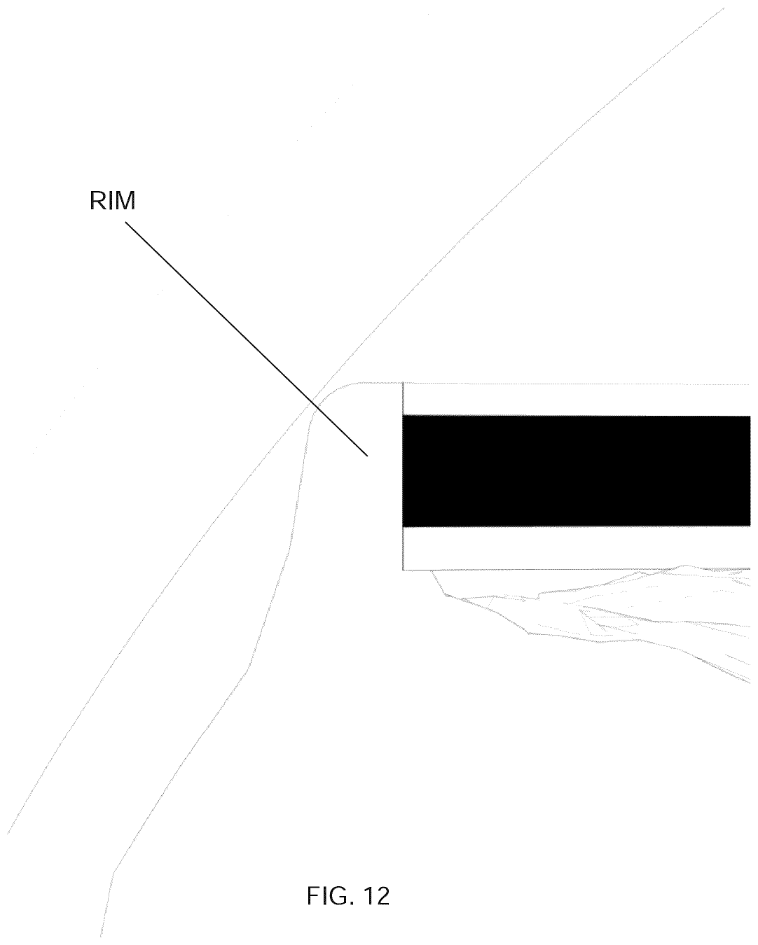

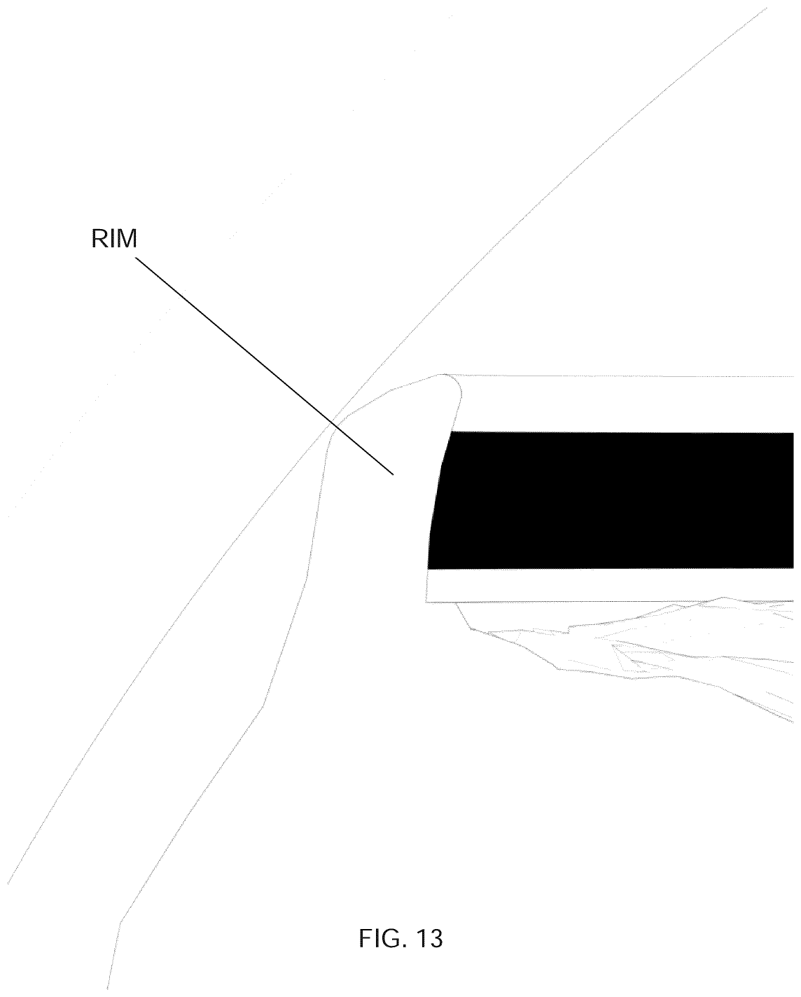

The rim structure exists as part of the core, but can be a separate component as well. This structure extends upward from the iris plane and the inner surfaces make up a portion of the anterior chamber. The surface that the TM coating is applied to can be vertical or angled depending on the laser procedure required. In this model, the Schlemm's canal is not necessary but can be included to aid in realism or anatomical marker. The SC can also be shown at the rear of the rim structure as seen in FIG. 11.

The use of lasers to disrupt compounds in the body is well known. An example of certain compounds, such as ink, being disrupted by a laser is tattoo removal. In tattoo removal, the laser is tuned and adjusted to specific parameters that cause the tattoo pigment to break into smaller pieces when shot with the laser.

In this example, tattoo ink is a fixed parameter, where the tattoo laser is modified and tuned for best performance. In our application, the femtosecond laser is the fixed parameter, as it is set to specific operating parameters for use on human tissue. The simulated TM therefore is specifically designed to respond similar to human tissue when fired upon by the femtosecond laser. The TM coating must perform similar to human tissue to be viable under these fixed set parameters.

The coating exhibits the same visual feedback, as well as energy requirements to remove a given section of tissue. The excised section must have the same material removal quantity and appearance. In addition to coating composition, thickness is also critical.

Additionally, the compound must break into smaller pieces when hit using laser settings identical to that used for human tissue (for safety, the laser might not have a separate set of settings for a simulated eye). For these criteria, the coating is formulated not to interact with the fluid used in the AC. When the coating is hit by a femtosecond laser, it separates from the TM surface and breaks into tiny particles. Since these tiny particles (that have been lasered) do not interact with the AC fluid, they act as a suspended solution. The ablation energy from the laser and the small, suspended particles being released, forms a plume of color that resembles blood reflux (blood that has aspired into the AC).

In live surgery, when the TM is hit by a femtosecond laser, this plume of blood reflux can hinder the surgeon's vision. Surgeons must train on how to overcome this diminished vision in the AC by either working around this obstacle, manipulating the eye to clear the view, or flushing out the AC. Being able to provide this realism of a blood reflux plume in a simulated eye will aid in surgeon training.

### Laser System Evaluation

Since this TM coating has been developed to perform within specific femtosecond laser criteria, it can also be used as a laser testing device. Before a patient surgery, the laser system can be functionally tested and/or calibrated to ensure proper working order. In this scenario, the simulated eye will be loaded to the laser system and test fired as if it were a patient undergoing treatment. The laser operator can then evaluate the treatment site of the simulated eye and determine the operational readiness of the laser system. The simulated eye can take the role of a go no-go gauge of machine usability. Being able to test fire the laser system prior to patient treatment will help reduce surgical complications.

Some of the causes of surgical complication that this can help to avoid include operator error and system error. Some operator errors that can be identified using this simulated eye include firing the laser in wrong location (targeting wrong tissue), improper use of laser, or wrong laser parameters to name a few.

Laser system errors that can be identified include system malfunctions. These could include either not firing, or firing incorrectly such as either over or under excising area. While under performance will lead to patient being under treated, over performance such as excessive energy can severely damage delicate tissue and may cause severe patient complications. The TM is a thin membrane that is being excised in this procedure. If the laser excision is too deep, additional eye structures, such as SC, collector channels or delicate nerves will also be excised.

If used as a calibration tool, an operator can adjust the laser settings based on the results of the simulated eye testing.

### Coating Description

The TM coating is a water-insoluble compound containing pigments. Some of the base ingredients include butanol, propanol, diacetone alcohol, and p-tert-butylphenol. These base compounds are combined with alcohol and an alcohol soluble dye. Insoluble pigments are added in a suspended state. The final color is selected to represent TM tissue color as well as blood reflux color once exposed to the laser beam.

What is claimed is:

1. An eye model for ophthalmic laser systems adapted to simulate tissue excision, comprising:
a lower core made of a rigid material;
a corneal dome mounted onto the lower core; and
an anterior chamber with an iris under the corneal dome; and
a rim surrounding the anterior chamber adapted to represent iridocorneal angle structures with a coating as the trabecular meshwork, wherein
a femtosecond laser can excise into the trabecular meshwork coating and rim.

2. The eye model of claim 1, wherein the coating of the trabecular meshwork forms a plume of particles when fired on by a femtosecond laser.
